(19) United States
(12) Patent Application Publication
(10) Pub. No.: US 2015/0209680 A1
(43) Pub. Date: Jul. 30, 2015

(54) GAME METHOD AND GAME SYSTEM FOR SHARING GAME SCENE

(71) Applicant: NHN Entertainment Corporation, Seongnam-si (KR)

(72) Inventor: Kyeng Jung LIM, Seongnam-si (KR)

(21) Appl. No.: 14/255,936

(22) Filed: Apr. 17, 2014

(30) Foreign Application Priority Data
Jan. 28, 2014 (KR) 10-2014-0010833

(51) Int. Cl. A63F 13/87; A63F 13/63

(52) U.S. Cl. CPC A63F 13/87; A63F 13/63

(57) ABSTRACT

Provided is a game method and game system for sharing a game scene. A game method of an App-and-Web hybrid type mobile game may include configuring a scene of the mobile game using a code of a webpage provided from a server of the mobile game, creating a link to an address of the webpage in response to a selection of a user, and sharing information on the scene with at least one other user associated with the user using the link.

### CROSS REFERENCE TO RELATED APPLICATION

This application claims priority from and the benefit of Korean Patent Application No. 10-2014-0010833, filed on Jan. 28, 2014, which is hereby incorporated by reference for all purposes as if fully set forth herein.

### BACKGROUND

1. Field

Exemplary embodiments of the present disclosure relate to a game method and game system for sharing a game scene.

2. Discussion of the Background

In mobile game services, a user may not be able to readily share information, for example, a current game scene and a character information scene, associated with a game character or the progress of a game, with another user while playing the game.

Generally, users may share only information that is set to be shared at a production point in time of a game service. As an example, a social network service (SNS)-based game has a function of providing information such as game scores or a ranking of a user to other users, such as friends, with whom the user has established a connection or relationship with. However, the shared or provided information is generally limited and only provided at fixed time points. Further, other users with whom the user is allowed to share information with may be limited to subscribers of a mobile game service or an SNS-related network. Thus, a user may not readily share various types of information with another user.

Additionally, to share and capture a game screen, the user may need to directly perform a plurality of processes such as controlling a capturing function of the terminal, finding and transmitting, or uploading an image that is created using the capturing function. This results in user inconvenience.

The above information disclosed in this Background section is provided to enhance understanding of the background of the disclosed subject matter, and therefore may contain information that does not form any part of the prior art nor what the prior art may suggest to a person of ordinary skill in the art.

### SUMMARY

Exemplary embodiments of the present disclosure provide a game method and game system of an Application (App)-and-Web hybrid type mobile game that may conveniently share information on a scene of the mobile game with other users through a link.

Exemplary embodiments of the present disclosure also provide a game method and game system that may provide information on a scene of a mobile game to another user who has not installed an App for playing the mobile game.

Additional features of the disclosed subject matter will be set forth in the description which follows, and in part will be apparent from the description, or may be learned by practice of the disclosed subject matter.

Exemplary embodiments of the present disclosure disclose a game method. The game method includes configuring, using a processor, a scene of a game using a code of a webpage provided from a server of the game, creating a link to an address of the webpage in response to a selection, and sharing, using the link, information on the scene.

Exemplary embodiments of the present disclosure also disclose a game system. The game system includes a request receiver and a code provider. The request receiver is configured to receive a request associated with a game from a terminal. The code provider is configured to provide, to the terminal, a webpage comprising a code. A scene of the game is configured by the terminal according to a scene configuring function in the code and information on the scene is shared using a link to an address of the webpage using a scene sharing function in the code.

It is to be understood that both the foregoing general description and the following detailed description are exemplary and explanatory and are intended to provide further explanation of the disclosed subject matter as claimed.

### BRIEF DESCRIPTION OF THE DRAWINGS

The accompanying drawings, which are included to provide a further understanding of the disclosed subject matter and are incorporated in and constitute a part of this specification, illustrate embodiments of the disclosed subject matter, and together with the description serve to explain the principles of the disclosed subject matter.

FIG. 1 illustrates an example of an environment in which a game service is provided according to exemplary embodiments of the present disclosure.

FIG. 2 illustrates an example of sharing a scene in which information on a predetermined character is included according to exemplary embodiments of the present disclosure.

FIG. 3 illustrates an example describing a photo zone according to exemplary embodiments of the present disclosure.

FIG. 4 is a flowchart illustrating a game method according to exemplary embodiments of the present disclosure.

FIG. 5 illustrates a configuration of a game system according to exemplary embodiments of the present invention.

FIG. 6 illustrates a configuration of a computer system according to exemplary embodiments of the present disclosure.

### DETAILED DESCRIPTION OF THE ILLUSTRATED EMBODIMENTS

Exemplary embodiments of the present disclosure will be described in detail with reference to the accompanying drawings. These exemplary embodiments will be described in detail for those skilled in the art in order to practice the disclosed subject matter. It should be appreciated that various exemplary embodiments of the disclosed subject matter may not be exclusive. For example, specific shapes, configurations, and characteristics described in an exemplary embodiment of the disclosed subject matter may be implemented in another exemplary embodiment without departing from the spirit and the scope of the disclosed subject matter. In addition, it should be understood that position and arrangement of individual components in each disclosed exemplary embodiment may be changed without departing from the spirit and the scope of the disclosed subject matter. Therefore, a detailed description described below should not be construed as being restrictive.

In the drawings, the size and relative sizes of layers and regions may be exaggerated for clarity. Like reference numerals in the drawings denote like elements. It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. For the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing exemplary embodiments and is not intended to be limiting of the disclosed subject matter. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present disclosure.

Hereinafter, exemplary embodiments of the disclosed subject matter are described in detail with reference to the accompanying drawings.

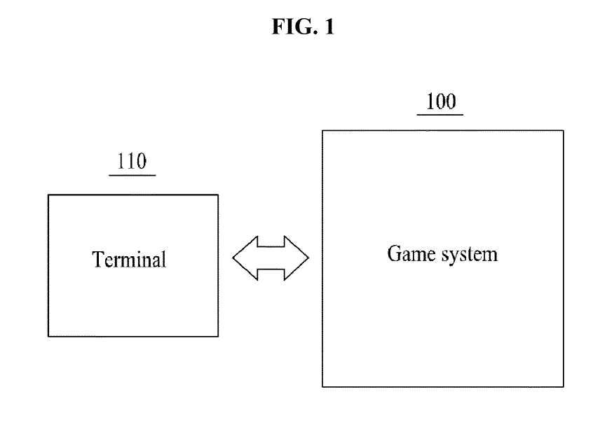

FIG. 1 illustrates an example of an environment in which a game service is provided according to exemplary embodiments of the present disclosure. A game system 100 and a terminal 110 are illustrated in FIG. 1. A user may connect to the game system 100 using the terminal 110 over a wired network or a wireless network to receive data required to play a game. The user may then play a game using the received data. In this example, data required to play a game may vary based on an attribute of the game.

The terminal 110 may refer to a user device, such as a personal computer (PC), a smart television (TV), and a mobile phone. In general, terminal 110 may be any electronic device capable of downloading an Application (App) or connecting to a webpage through a network, such as the Internet. It should therefore be understood that terminal 110 may include various components, such as a memory, a transceiver, a processor, and an input/output unit.

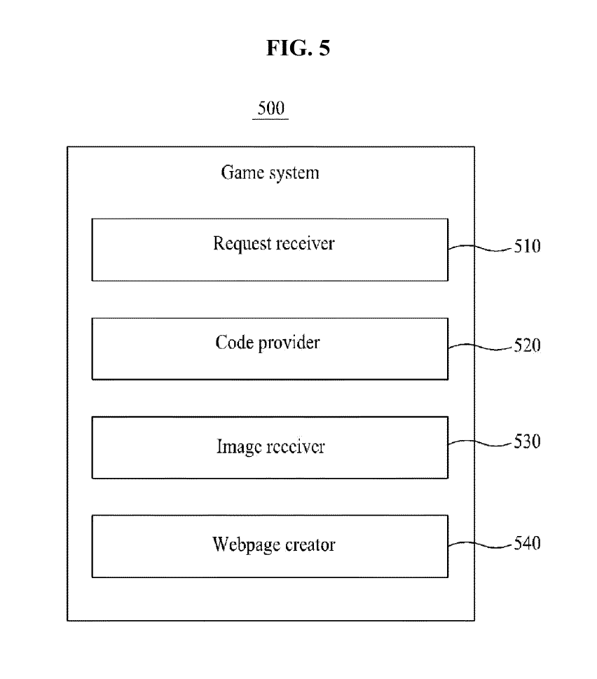

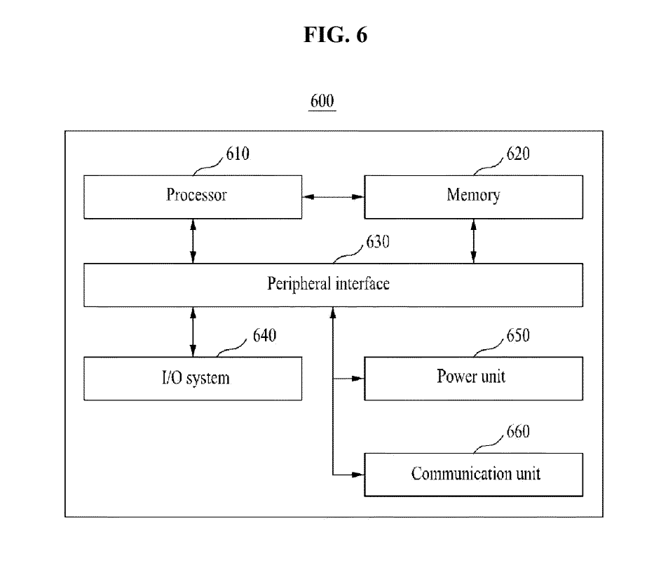

The game system 100 may refer to a server that is configured to manage all data related to execution and management of a game, to store user information, and to provide data to the terminal 110 for the game. The server may include various combinations of hardware and/or software. The game system 100 will be described in more detail below with reference to FIGS. 5 and 6.

The game may be a mobile game that is of an App-and-Web hybrid type. Thus, the mobile game may be provided through the Internet on a webpage or through an Application that may be downloaded on any terminal. A scene of the mobile game may be configured by the terminal 110 according to a control of a code that is included in a webpage transmitted from the game system 100 to the terminal 110. For example, the code may be produced based on Hyper Text Markup Language 5 (HTML5). HTML5 refers to a standard of HTML, which is a basic programming language used to create a webpage document. HTML5 may achieve special graphics effects on an Internet browser and may provide a function for enabling a user to readily enjoy music or motion pictures, without a need to install a separate program, for example, a predetermined App or Active X, flash, Silverlight, and JAVA FX. In this example, a mobile App may control terminal 110 to receive a webpage created to be suitable for the mobile App and to display the received webpage on a screen. A web browser of the terminal 110 may provide a scene of a game including a variety of graphics effects to a user based on a code included in the webpage. In general, various suitable programming languages may be used, and exemplary embodiments of the disclosed subject matter are not limited to using HTML 5.

All the scenes of a game may be configured using the web. Accordingly, game scenes may be configured using a code of a webpage, and thus, when only an address of the webpage is provided, other users may also share the scenes without installing an App or joining a service. For example, with respect to a scene that represents information on a predetermined character acquired by a user, another user may be provided with the corresponding scene with a link to a webpage in which a code constituting the corresponding scene is included and without requiring the other user to install an App or join a service. In some cases, a portion of a scene displayed on a single screen may be configured using the web. The remaining portion of the scene may be configured based on an App installed in a terminal and thereby displayed.

Additionally, in a mobile game according to exemplary embodiments of the present disclosure, portions configured through a plurality of webpages and portions configured through an App may be mixed and utilized.

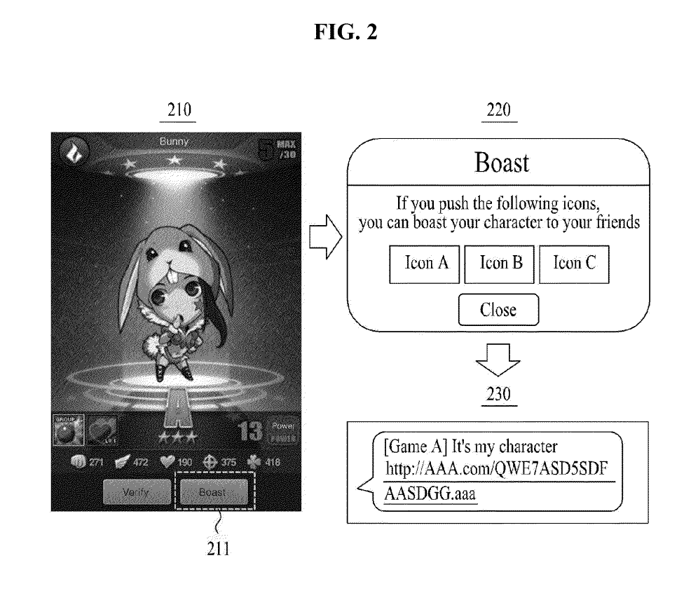

FIG. 2 illustrates an example of sharing a scene in which information on a character is included according to exemplary embodiments of the present disclosure.

A first screen 210 shows an example of a scene in a mobile game configured using the web. The first screen 210 displays information on a character acquired by a user and a user interface 211, “boast”. The first screen 210 may be configured based on a code of a webpage provided from game system 100, which manages data related to the mobile game.

In response to a user selection of the user interface 211, “boast”, in the first screen 210 of terminal 110, a user interface for selecting a path for “boast” may be provided to the user. “Boast” may be an example of a user interface used for sharing, with another user, information about a character appearing in a scene.

A second screen 220 may be displayed in response to selection of the user interface 211, “boast”, in the first screen 210. The second screen 220 displays an icon A, which refers to a function for sharing a scene through a first short message service (SMS), icon B, which refers to a function for sharing a scene through a first social network service (SNS), and icon C, which refers to a function for sharing a scene through a second SNS.

If the user selects icon A, the terminal 110 may transmit a SMS message to another user using a telephone number or E-mail address of the other user. The SMS message may include a link to an address of a webpage corresponding to the first screen 210.

A third screen 230 shows an example of the SMS message sent by terminal 110, received by a terminal of another user, and displayed on a screen of a terminal of the other user. For example, the SMS message may include a link to a webpage. In response to a selection of the link included in the SMS message by the other user, the webpage may be provided to the terminal of the other user. A web browser included in the terminal of the other user may configure a scene displayed on the first screen 210 based on the code of the corresponding webpage and may display the scene on a screen. Accordingly, the user and the other user may share information on the character appearing on the first screen 210.

If the user selects icon B on the second screen 220, a link to an address of a webpage corresponding to the first screen 210 may be uploaded to a destination (e.g., profile page or timeline) within a first SNS of the user. In some cases, the link may be displayed to other users with whom the user has established a connection or relationship with in the first SNS. In response to a click on the displayed link, the scene displayed on the first screen 210 may be provided to the other users.

If the user selects icon C on the second screen 220, a link to an address of a webpage corresponding to the first screen 210 may be uploaded to a destination within a second SNS of the user.

Also, as described above, when the code included in the webpage is created using HTML5, special graphics effects may be achieved on an Internet browser without installing a separate program, and a function that enables a user to readily enjoy music or motion pictures may be provided. Accordingly, other users may also share a variety of functions, for example, animation and background effect of a character, included in the corresponding webpage.

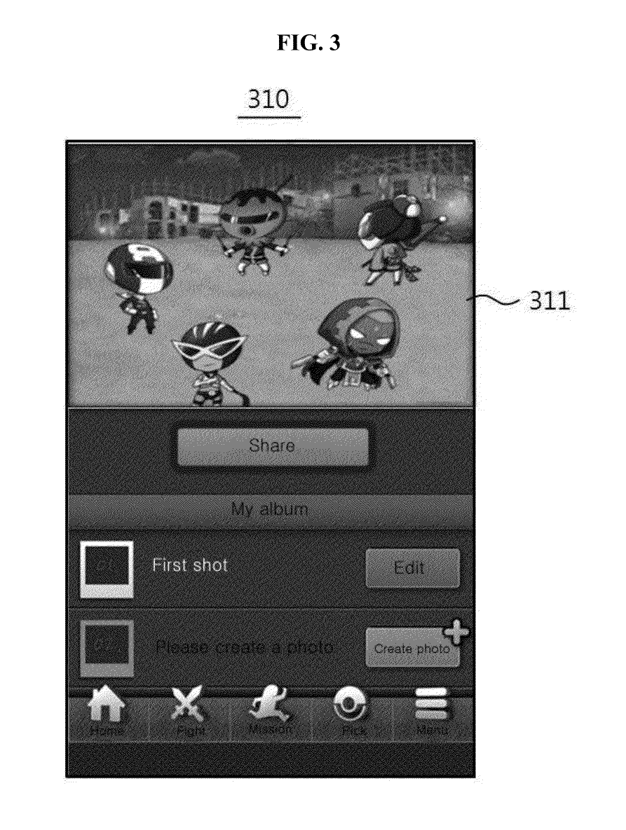

FIG. 3 illustrates an example describing a photo zone according to exemplary embodiments of the present disclosure. The photo zone may be a service that enables a user to create, manage, upload, and share an image associated with the progress of a game. A screen 310 of FIG. 3 shows an example of the photo zone. An image 311 is an example of a photo created through a function of the photo zone, such as a function that enables the user to deploy characters of the user using a variety of methods and to select a background. The created image 311 may be shared with other users through a user interface, such as “Share”. For example, once the user creates the image 311, the created image 311 may be uploaded to game system 100 according to a control of an App. The game system 100 may create a webpage including at least the image 311. A link to the webpage may be provided to another user designated by the user or may be uploaded to a SNS associated with the user to be shared with other users. In some cases, the webpage may further include an invitation function to the mobile game and information such as an identifier of the user or an invitation code.

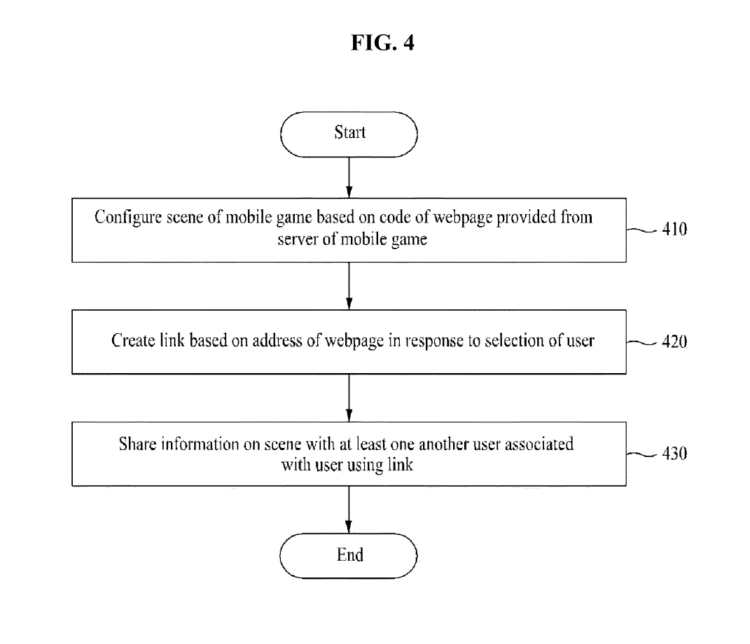

FIG. 4 is a flowchart illustrating a game method according to exemplary embodiments of the present disclosure. The game method may provide an App-and-Web hybrid type mobile game and may be performed by terminal 110 of a user.

The terminal 110 may configure a scene of the mobile game using a code of a webpage provided from the game system 100 (e.g., server) of the mobile game (410). For example, the game system 100 may transmit a code for configuring a webpage to the terminal 110 and a web browser of the terminal 110 may configure a scene according to the code and may display the scene on a screen of the terminal 110. As described above, the code may be produced based on HTML5 and a scene in which a variety of functions, such as animation, music, and a motion picture, are included may be provided.

Next, the terminal 110 may create a link to an address of the webpage in response to a selection of the user (420). For example, the terminal 110 may create the link in response to an event occurring through a user interface, such as selection of a “share” button, as shown in FIG. 3. In this example, the user interface may be provided based on the code of the webpage and may be provided by an App installed in the terminal 110.

Next, the terminal 110 may share information on the scene with at least one other user connected to the user, using the link (430). For example, the terminal 110 may share information on the scene by providing the link to at least one other user using at least one of a SNS, a short message service (SMS), a multimedia message service (MMS), and an email associated with the user, regardless of whether the at least one other user has joined a service of the mobile game. For example, information on the scene may include information on at least one of characters of the mobile game.

Although not illustrated, the game method may further include creating an image using at least one of characters of the mobile game acquired by the user and providing the image to the game system 100. In some cases, these non-illustrated operations may be selectively included in the game method and may be performed by the terminal 110.

The game system 100 may receive the created image and may create a webpage including the received image. In this example, the terminal 110 may configure an image of the scene of the mobile game using the code of the webpage. The screen 310 of FIG. 3 may be a scene configured through an App or a scene configured using the web. The game system 100 may enable the user to share the corresponding image through a link to the webpage in which the corresponding image is included. A webpage that provides an image to the user may be programmed or configured in a different manner than a webpage that provides an image via a link to another user.

FIG. 5 illustrates a configuration of a game system 500 according to exemplary embodiments of the present disclosure. The game system 500 of FIG. 5 may correspond to the game system 100 of FIG. 1, and may provide an App-and-Web hybrid type mobile game. Referring to FIG. 5, the game system 500 may include a request receiver 510, a code provider 520, an image receiver 530, and a webpage creator 540. The image receiver 530 and the webpage creator 540 may be selectively included in the game system 500.

The image receiver 510 may receive a request associated with the progress of a mobile game from a terminal 110. For example, the request may refer to a request for starting a game, a request for starting a predetermined menu, or a request for starting a predetermined game stage.

The code provider 520 may provide a webpage having a predetermined code to the terminal 110. The provided code may include a scene configuring function of controlling the terminal 110 to configure the scene of the mobile game and a scene sharing function of controlling the terminal 110 to share information on the scene with at least one other user connected to the user using a link to an address of the webpage. A method of configuring the scene of the mobile game or sharing information on the scene with another user is described above and thus, a further detailed description related thereto is omitted.

The image receiver 530 may receive an image that is provided by the terminal 110 using at least one of characters of the mobile game acquired by the user.

The webpage creator 540 may create a webpage in which the received image is included. The code provider 520 may transmit, to the terminal 110, a code of the webpage in which the image is included. A scene in which the image is included may be configured by the terminal 110 using the code of the webpage.

In some cases, in response to a request of the terminal 110, a link to the webpage in which the image is included may be provided to another user and the corresponding image may be shared with the other user. In some cases, the image may be shared with other users by initially transmitting the link to the webpage to the terminal 110 and then transmitting the link from the terminal 110 to a terminal of another user.

As described above, according to exemplary embodiments of the present disclosure, in an App-and-Web hybrid type mobile game, information on a scene of a mobile game may be conveniently shared with other users through a link to an address of a webpage by configuring a scene of the mobile game using a code of the webpage and thereby servicing the mobile game. Also, because scenes of the mobile game are provided using web-based technology, information on the scene of the mobile game may be provided to another user not having installed an App for playing the corresponding mobile game or not having joined a service for the corresponding mobile game.

Elements of the game system 500, such as the request receiver 510, code provider 520, image receiver 530, and webpage creator 540 described herein may be implemented using hardware components, software components, or a combination thereof. For example, as noted above, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

FIG. 6 illustrates a configuration of a computer system 600 according to exemplary embodiments of the present disclosure. The game system 100 of FIG. 1 and/or the terminal 110 of the user may be configured as the computer system 600 of FIG. 6. Referring to FIG. 6, the computer system 600 may include at least one processor 610, a memory 620, a peripheral interface 630, an input/output (I/O) system 640, a power unit 650, and a communication unit 660.

FIG. 6 is only an example of the computer system 600 and thus, the computer system 600 may further include additional components not illustrated in FIG. 6, or may be configured to couple at least two components. For example, a computer system for terminal 110 may further include a touch screen or a sensor in addition to components of FIG. 6. A circuit for radio frequency (RF) communication may be included in the communication unit 660. Components to be included in the computer system 600 may be configured as software and hardware including an integrated circuit specialized for processing at least one signal or an application.

The memory 620 may include, for example, high-speed random access memory (RAM), a magnetic disk, static RAM (SRAM), dynamic RAM (DRAM), read only memory (ROM), flash memory, or non-volatile memory. The memory 620 may include a command set, a variety of data, or a software module required for operating the computer system 600. Here, an access to the memory 620 from another component such as the processor 610 or the peripheral interface 630 may be controlled by the processor 610.

The peripheral interface 630 may couple an input and/or output peripheral device with the processor 610 and the memory 620. The processor 610 may perform a variety of functions for the computer system 600 and may process data by executing the software module or the command set stored in the memory 620.

The I/O system 640 may couple a variety of I/O peripheral devices with the peripheral interface 630. For example, the I/O system 640 may include a controller configured to couple a monitor, a keyboard, a mouse, a printer, or if necessary, a peripheral device such as a touch screen or a sensor, with the peripheral interface 630. I/O peripheral devices may be coupled with the peripheral interface 630 without using the I/O system 640.

The power unit 650 may supply power to all of or a portion of the components of a terminal. For example, the power unit 650 may include a power management system, at least one power source such as a battery or alternating current (AC), a charging system, a power failure detection circuit, a power converter or inverter, a power state indicator, or predetermined other components for producing, managing, and distributing power.

The communication unit 660 enables communication with another computer system using at least one external port. In some cases, as described above, the communication unit 660 communicates with another communication system through a RF circuit by transmitting or receiving a RF signal.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present disclosure may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present disclosure, or vice versa.

It will be apparent to those skilled in the art that various modifications and variations can be made in the present disclosure without departing from the spirit or scope of the disclosed subject matter. Thus, it is intended that the present disclosure cover the modifications and variations of the disclosed subject matter provided they come within the scope of the appended claims and their equivalents.

What is claimed is:

1. A game method, comprising:
configuring, using a processor, a scene of a game using a code of a webpage provided from a server of the game;
creating a link to an address of the webpage in response to a selection; and
sharing, using the link, information on the scene.

2. The method of claim 1, further comprising executing, using the code, a function for adding, to the scene, a user interface for requesting creation of the link to the address of the webpage, and
wherein creating the link comprises creating the link in response to an input of a user through the user interface.

3. The method of claim 1, wherein the sharing comprises providing the link to at least one other user using at least one of a social network service (SNS), a short message service (SMS), a multimedia message service (MMS), and an email associated with the user.

4. The method of claim 1, wherein information on the scene comprises information on at least one character in the game.

5. The method of claim 1, further comprising:
creating an image using at least one of characters of the game; and
providing the image to the server,
wherein configuring the scene comprises configuring the scene of the game using a code of a webpage configured by the server.

6. The method of claim 1, wherein the code comprises Hyper Text Markup Language 5 (HTML5).

7. A non-transitory computer-readable recording medium storing a program to implement the method of claim 1.

8. A game system, comprising:
a request receiver to receive a request associated with a game from a terminal; and
a code provider to provide, to the terminal, a webpage comprising a code,
wherein a scene of the game is configured by the terminal according to a scene configuring function in the code and information on the scene is shared using a link to an address of the webpage using a scene sharing function in the code.

9. The game system of claim 8, wherein:
a user interface to request creation of the link is added according to an adding function in the code; and
the link is created by the terminal in response to an input of the a through the user interface.

10. The game system of claim 8, wherein information on the scene is shared by providing the link to at least one other user using at least one of a social network service (SNS), a short message service (SMS), a multimedia message service (MMS), and an email associated with the user.

11. The game system of claim 8, wherein information on the scene comprises information on at least one of characters of the game.

12. The game system of claim 8, further comprising:
an image receiver to receive an image created by the terminal using at least one of characters of the game; and
a webpage creator to create the webpage comprising the image,
wherein the code provider is configured to transmit, to the terminal, the code of the webpage, and a scene comprising the image is configured by the terminal using the code.
